(19) United States
(12) Patent Application Publication
(10) Pub. No.: US 2014/0170509 A1
(43) Pub. Date: Jun. 19, 2014

(54) ARMOURING MATERIAL FOR AIR SECONDARY BATTERY, PRODUCTION METHOD OF ARMOURING MATERIAL FOR AIR SECONDARY BATTERY, AND SECONDARY BATTERY

(71) Applicant: SHOWA DENKO PACKAGING CO., LTD., Isehara-shi (JP)

(72) Inventors: Kensuke NAGATA, Hikone-shi (JP); Makoto KARATSU, Hikone-shi (JP)

(73) Assignee: SHOWA DENKO PACKAGING CO., LTD., Isehara-shi (JP)

(21) Appl. No.: 14/104,189

(22) Filed: Dec. 12, 2013

(30) Foreign Application Priority Data
Dec. 17, 2012 (JP) 2012-274800

(51) Int. Cl. H01M 2/02; H01M 12/08

(52) U.S. Cl. CPC H01M 2/0287; H01M 12/08
USPC 429/407; 156/280

(57) ABSTRACT

An armouring material for use in an air secondary battery, including:
an armouring sheet (2) constituted by laminating an outer layer (21) including heat-resistant resin film, a metal foil layer (22), and an inner layer (23) including a thermoplastic resin film, being equipped with an opening part (12) for taking oxygen in, perforating through the outer layer, the metal foil layer and the inner layer, and an oxygen-permeable membrane (3) being joined to the inner layer side in an opening part periphery (12a) and covering the opening part. The oxygen-permeable membrane is constituted from a porous fluororesin, a joining surface of outer periphery (3a) of the oxygen-permeable membrane is equipped with a primer layer (3c), and an adhesive layer (5) is provided at least in a space between the primer layer and the inner layer of the armouring sheet, to adhere the oxygen-permeable membrane to the armouring sheet.

### BACKGROUND OF THE INVENTION

### Field of the Invention

The present invention relates to an armouring material for air secondary battery, a production method of the armouring material for air secondary battery, and an air secondary battery.

Priority is claimed on Japanese Patent Application No. 2012-274800, filed Dec. 17, 2012, the content of which is incorporated herein by reference.

Corresponding to miniaturization and portability of electronic devices such as a video camera, a notebook-sized personal computer, a cellular phone, downsizing and lightweighting have been required to the battery which is the driving force, high-performance lithium secondary batteries have been spread.

Recently, upsizing of lithium secondary batteries is considered in order to apply lithium secondary batteries to an in-vehicle electric power supply of an electric vehicle or a hybrid vehicle.

Now, since a space for onboard electric power supply in a vehicle is limited and shape of the space for onboard electric power supply is unsettled, downsizing (slimming), lightweighting and freeing of shape are required to a lithium secondary battery for onboard electric power supply in a vehicle, similarly to the circumstances of electronic device. For example, as an armouring material of such a lithium secondary battery, the armouring sheet disclosed in the following Patent Document 1 is known. The armouring sheet disclosed in Patent Document 1 is constituted by laminating an outer layer made of a resin layer, with an inner layer made of aluminum foil and a resin layer, in which the resin layer of the inner layer is equipped with heat-sealing properties. Such an armouring sheet is processed into a bag to form a packaging container, cells are inserted into the resultant container, then heat-sealing the inner layers of the armouring sheet with each other, thereby obtaining a lithium secondary battery which excels in both sealing and degree of free of shape.

In addition, recently, an air secondary battery attracts attention, the air secondary battery using lithium or aluminium as a negative electrode active material, and atmospheric oxygen in the air as a positive electrode active material.

Since the air secondary battery uses atmospheric oxygen as a positive electrode active material, improvement of energy density per battery volume is expected.

For example, in a lithium air secondary battery, which is a kind of an air secondary battery, a metal lithium as a negative electrode active material, and the electrolyte are sealed by an armouring material, the armouring material is equipped with a port part for taking oxygen in, and an air electrode is applied to the port part (see Patent Document 2). The air electrode is composed of an oxygen-permeable membrane and a catalyst layer, the oxygen-permeable membrane is joined to the port part, thereby placing the air electrode at the port part. As an oxygen-permeable membrane, for example, a porous ceramic material is known. As for an armouring material, adoption of an armouring sheet for the use of conventional lithium secondary battery has been considered.

It is required for the oxygen-permeable membrane as above to have a property of taking oxygen as a positive electrode substance in from an ambient efficiently. In addition, barrier performance against water is required for protecting metallic lithium as a negative electrode substance and electrolytic solution (electrolyte). For this reason, recently, an oxygen-permeable membrane constituted from porous fluororesin has been proposed, as a material for membrane which is capable of both taking oxygen in easily from an ambient and preventing water from invading.

### PRIOR ART DOCUMENTS

### Patent Documents

[Patent Document 1] Japanese Patent No. 4,431,822
[Patent Document 2] Japanese Patent Laid-Open No. 2011-96492

### SUMMARY OF THE INVENTION

### Problem to be Solved by the Invention

However, in the case in which the porous fluororesin membrane as above is used as an oxygen-permeable membrane, the adhering between the armouring sheet and the oxygen-permeable membrane may be insufficient, because the thermoplastic resin having laminating constitution which constitutes an armouring sheet is hard to be adhered. Because of this, in the conventional air secondary battery, there is a problem that electrolyte leaks out or water penetrates through the joining portion between the oxygen permeable membrane and the armouring sheet to shorten the life of the air secondary battery. In addition, there was the case where leaking of electrolyte or penetration of water through the oxygen-permeable itself, thereby shortening the life of the air secondary battery.

The present invention was made in view of the aforementioned circumstances. It is an object of the present invention to provide an armouring material for the use of a secondary battery, having excellent joining performance between an oxygen-permeable membrane and the armouring sheet, the oxygen-permeable membrane excelling in oxygen-permeability and water-barrier performance, being capable of preventing electrolyte from leaking out. And further, it is another object of the present invention to provide a production method of an armouring material for the use of a secondary battery, having excellent joining performance between an oxygen-permeable membrane and the armouring sheet, the oxygen-permeable membrane excelling in oxygen-permeability and water-barrier performance. In addition, it is still another object of the present invention to provide an air secondary battery equipped with an oxygen-permeable membrane which excels in oxygen-permeability and water-barrier performance, being capable of preventing electrolyte from leaking out.

### Means to Solve the Problem

In order to dissolve above-mentioned problems, the inventors of the present invention have studied energetically, and as a result, they found that, upon joining an aluminum laminate film using thermoplastic resin as a material for film, with the oxygen-permeable membrane made of porous fluororesin membrane by adhering, the adhering ability between the armouring sheet and an oxygen-permeable membrane can be heightened by effecting pre-treatment and adjusting the layer consisting of adhesive, thereby completing the present invention.

That is, the present invention relates to:

[1] An armouring material for use in an air secondary battery, comprising an armouring sheet constituted by laminating an outer layer including heat-resistant resin film, a metal foil layer, and an inner layer including a thermoplastic resin film, being equipped with an opening part for taking oxygen in, perforating through the outer layer, the metal foil layer and the inner layer, and

an oxygen-permeable membrane being joined to the inner layer side in the opening part periphery so as to cover the opening part,

wherein the oxygen-permeable membrane is constituted from a porous fluororesin in which fluorine type resin particles are aggregated, the joining surface of outer periphery of the oxygen-permeable membrane is equipped with a primer layer, and an adhesive layer is provided at least in the space between the primer layer and the inner layer of the armouring sheet, thereby adhering the oxygen-permeable membrane to the armouring sheet.

[2] The armouring material for use in an air secondary battery as set forth in [1], further comprising a primer layer on the joining surface at the side of the oxygen-permeable membrane of the adhesive layer, and the space between the primer layer formed on the side of oxygen-permeable membrane and the primer layer formed at the side of the armouring sheet is joined.

[3] The armouring material for use in an air secondary battery as set forth in [1] or [2], wherein the fluorine type resin is polytetrafluoroethylene resin, poly(vinylidene fluoride) resin, or copolymer of tetrafluoroethylene and propylene hexafluoride (EFP).

[4] The armouring material for use in an air secondary battery as set forth in any one of [1] to [3], wherein the primer layer is a layer which is activated by a compound material having a molecular constitution containing at least one or more of hydroxyl group, carbonyl group, amino group, nitro group, cyano group, silanol group, carboxyl group, isocyanate group, amide group, and epoxy group; or a primer consisting of a mixed material of peroxide and silica fine particles.

[5] The armouring material for use in an air secondary battery as set forth in any one of [1] to [4], wherein the adhesive layer is composed of cyanoacrylic type adhesive.

[6] The armouring material for use in an air secondary battery as set forth in any one of [1] to [5], wherein the inner layer is composed of an acid denaturated polyolefin resin film.

[7] The armouring material for use in an air secondary battery as set forth in any one of [1] to [6], wherein the armouring material is composed of polyamide resin film, or polyester resin film.

[8] An air secondary battery comprising the armouring material for use in an air secondary battery as set forth in any one of [1] to [7].

[9] A process for producing the armouring material for use in an air secondary battery as set forth in any one of [1] to [7], comprising:
a step of forming the armouring sheet constituted by laminating an outer layer including heat-resistant resin film, a metal foil layer, and an inner layer including a thermoplastic resin film, being equipped with an opening part for taking oxygen in, perforating through the outer layer, the metal foil layer and the inner layer;
a step of conducting a primer treatment on the oxygen-permeable membrane which is constituted from a porous fluororesin in which fluorine type resin particles are aggregated, thereby forming a primer layer on the outer periphery of the oxygen-permeable membrane;
a step of applying an adhesive to at least the joining surface in the vicinity of the opening in the surface at the side of inner surface of the armouring sheet to form an adhesive layer; and
a step of joining the oxygen-permeable membrane to the circumference of the opening of the armouring sheet by the adhesive layer.

[10] The process for producing the armouring material for use in an air secondary battery as set forth in [9], further comprising:
a step of forming a primer layer on the joining surface at the side of the oxygen-permeable membrane of the adhesive layer, and joining the primer layer formed at the side of the oxygen-permeable membrane with the primer layer formed at the side of the adhesive layer.

[11] The process for producing the armouring material for use in an air secondary battery as set forth in [9] or [10], wherein the primer layer is formed by activation using a primer consisting of a compound material having a molecular constitution containing at least one or more of hydroxyl group, carbonyl group, amino group, nitro group, cyano group, silanol group, carboxyl group, isocyanate group, amide group, and epoxy group; or a primer consisting of a mixed material of peroxide and silica fine particles.

[12] The process for producing the armouring material for use in an air secondary battery as set forth in any one of [9] to [11], wherein the adhesive layer is formed from cyanoacrylic type adhesive.

### Effect of the Invention

According to the armouring material for use in an air secondary battery of the present invention, porous fluororesin membrane is used as the oxygen-permeable membrane, the primer layer is formed on the joining surface of outer periphery of the oxygen-permeable membrane, with respect to joining the inner layer of the armouring sheet including the thermoplastic resin film, with the oxygen-permeable membrane, and further, the adhesive layer is formed at least in the space between the primer layer and the inner layer of the armouring sheet, thereby adhering the oxygen-permeable membrane to the armouring sheet. And as a result, excellent oxygen permeability and water barrier performance can be obtained, the joining strength between the armouring sheet and the oxygen-permeable membrane can be improved to heighten the sealing property therebetween, and leaking out of electrolyte and invasion of water from the joining portion can be prevented.

In addition, according to the air secondary battery of the present invention, it is equipped with the armouring material for use in an air secondary battery which excels in both oxygen permeability and the joining strength between the inner layer and the oxygen-permeable membrane. By this, battery characteristics can be improved, and leaking out of electrolyte and invasion of carbon dioxide from the outside can be prevented, thereby preventing a short life of the air secondary battery.

Moreover, according to the production method of the armouring material for use in an air secondary battery of the present invention, which adopts the process including, upon joining the armouring sheet inner layer including thermoplastic resin film with oxygen-permeable membrane made of porous fluororesin, a step of forming a primer layer on the outer periphery of the oxygen-permeable membrane, and a step of forming an adhesive layer by applying an adhesive to at least the joining surface in the vicinity of the opening in the surface at the side of inner surface of the armouring sheet. Thereby, oxygen-permeablity and barrier performance against water can be improved, the joining strength between the inner layer of the armouring sheet and the oxygen-permeable membrane can be improved to heighten the sealing property therebetween, and as a result, the armouring material for use in an air secondary battery being capable of preventing leaking out of electrolyte and invading of water can be obtained.

### BRIEF DESCRIPTION OF DRAWINGS

FIG. 1 is a perspective view showing the armouring material for use in an air secondary battery which is an embodiment of the present invention.

FIG. 2 is a cross-sectional view showing the armouring material for use in an air secondary battery which is an embodiment of the present invention.

FIG. 3 is a partial cross-sectional view showing the armouring sheet which constitutes the armouring material for use in an air secondary battery which is an embodiment of the present invention.

FIG. 4 is a partial cross-sectional view showing the joining portion of the oxygen permeable membrane and the armouring sheet which constitute the armouring material for use in an air battery which is an embodiment of the present invention.

FIG. 5 is a partial cross-sectional view showing an example of the air secondary battery which is an embodiment of the present invention.

FIG. 6 is a partial cross-sectional view showing another example of the air secondary battery which is an embodiment of the present invention.

### DETAILED DESCRIPTION OF THE INVENTION

It will be explained below, with respect to the embodiment of the armouring material for use in an air secondary battery, the production method of the armouring material for use in an air secondary battery, and the air secondary battery, referring to the drawings.

[Armouring Material for Use in an Air Secondary Battery]

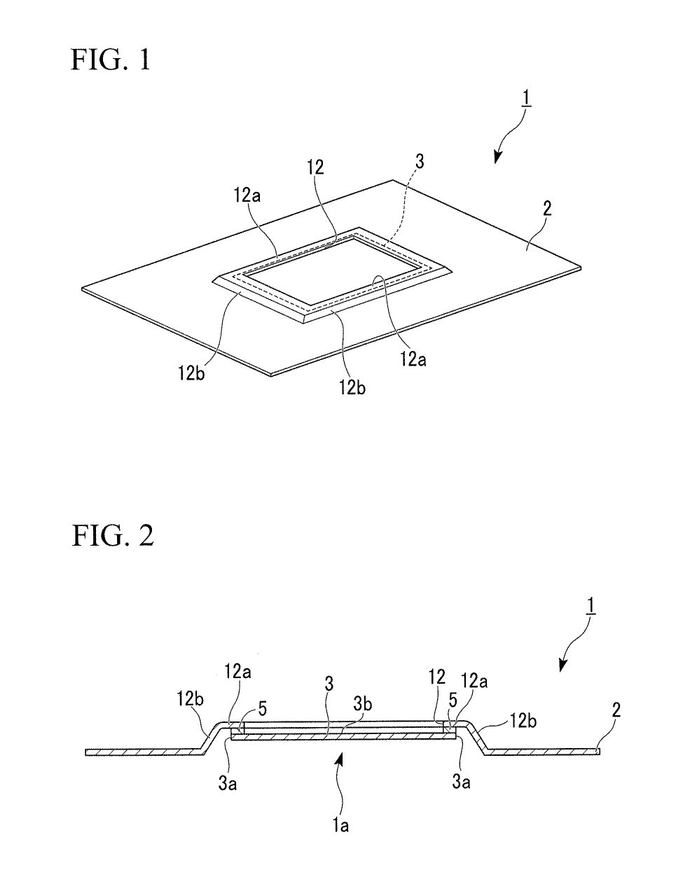

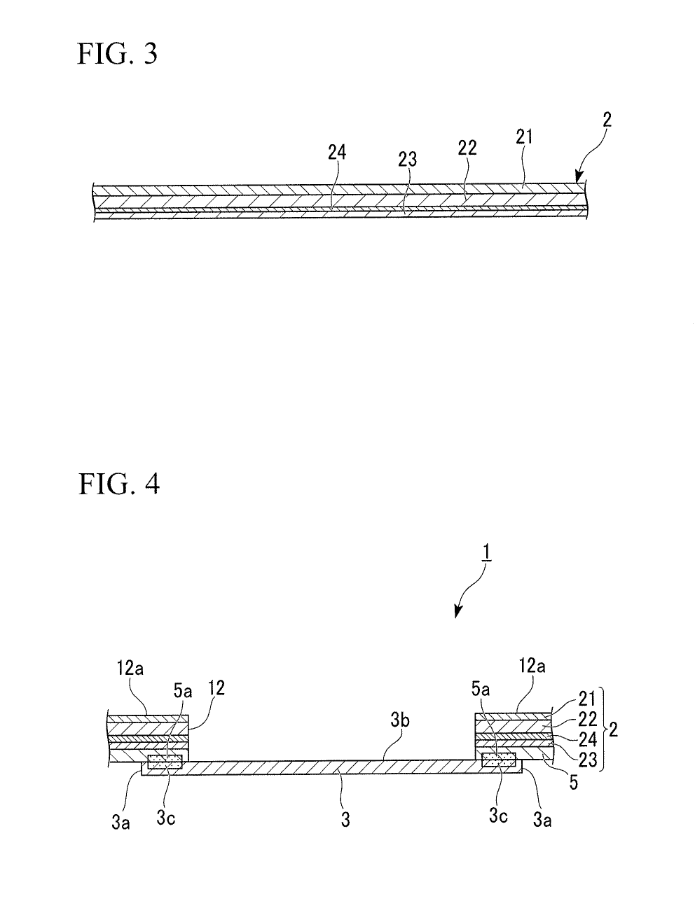

The armouring material 1 for use in an air secondary battery (it will be called as an armouring material below) which is a preferred one of this embodiment is, as shown in FIGS. 1 and 2, constituted from the armouring sheet 2 which is equipped with the opening part 12 for taking oxygen in, and the oxygen permeable membrane 3 which is joined to the opening part periphery 12a so as to cover the opening part 12. The armouring sheet 2 is, as shown in FIG. 3, constituted by laminating at least the outer layer 21, the metal foil layer 22, and the inner layer 23. It should be noted that, in the embodiment shown in FIG. 3, the adhesive layer 24 for laminating is disposed into between the metal foil layer 22 and the inner layer 23. The opening part 12 for taking oxygen in is formed to perforate through the outer layer 21, the metal layer 22, the adhesive layer 24, and the inner layer 23. The oxygen permeable membrane 3 is joined to a side of the inner layer 23 of the armouring sheet 2, by way of the adhesive layer 5.

More in detail, the armouring sheet 2 is equipped with the slant part 12b having a ring shape which is pressed to protrude to the outer layer side, and the opening part periphery 12a which is connected to the slant part 12b, and the opening part 12 is surrounded by the opening part periphery 12a. To the inner layer side of the opening part periphery 12a, the oxygen permeable membrane 3 is joined over all-around of the opening part periphery 12a. The oxygen permeable membrane 3 is larger than the opening part 12, and the part which is run out from the opening part 12 serves as the outer periphery 3a of the oxygen permeable membrane 3, and the outer periphery 3a is joined to the inner layer side of the opening part periphery 12a.

In addition, as shown in FIG. 4, the oxygen permeable membrane 3 is made of a porous fluororesin membrane in which fluororesin particles are aggregated, and the primer layer 3c is formed on the joining surface of the outer periphery 3a of the oxygen permeable membrane 3. And, in this embodiment, the adhesive layer 5 is formed at least in the space between the primer layer 3c and the inner layer 23 of the armouring sheet 2 at least, in the example shown in the drawing, the adhesive layer 5 is formed in the opening part periphery 12a of the inner layer 23.

The oxygen permeable membrane 3 is adhered to the armouring sheet 2 by forming the adhesive layer 5 as such to constitute the armouring material 1.

In addition, by forming a ring-shaped slant part 12b and the opening part periphery 12a in the armouring sheet 2, and further by joining the oxygen permeable membrane 3 to the opening part periphery 12a, by way of the adhesive layer 5, the recess 1a is formed at the inner layer side of the armouring material 1. Into the recess 1a, a negative electrode or an air electrode of an air secondary battery is contained.

It will be explained in detail below, with respect to the constitutional members of the armouring material 1.

(Armouring Sheet)

The armouring sheet 2 is, as mentioned above, constituted by laminating the outer layer 21, the metal foil layer 22, and the inner layer 23. The gap between the inner layer 23 and the metal foil layer 22, the adhesive layer 24 is interposed. In addition, the gap between the outer layer 21 and the metal foil layer 22, not-shown adhesive layer is interposed.

<Outer Layer>

The outer layer 21 is constituted from at least one or more of heat-resistant resin film. The outer layer 21, in the case in which it is constituted from two or more of heat-resistant resin films, is preferably constituted by laminating two or more of heat-resistant resin films, with interposing an adhesive layer therebetween.

The heat-resistant resin film constituting the outer layer 21 serves to secure formability upon forming the recess 1a in the armouring material 1. A stretched film of polyamide (nylon) or polyester resin is preferably used. In addition, the melting point of the heat-resistant resin film constituting the outer layer 21 is preferably higher than the melting point of the thermoplastic resin film constituting the inner layer 23. As a result, it becomes possible to conduct heat sealing certainly of the armouring material 1 in producing air secondary battery.

The thickness of the outer layer 21 preferably ranges around from 10 to 50 μm, more preferably around from 15 to 30 μm. If the thickness is 10 μm or higher, then elongation of stretched film is unlikely to run short, when molding the armouring material 1, necking is unlikely to occur in the metal foil layer 22, and molding failure is unlikely to occur. In addition, if thickness is 50 μm or less, then the effect of formability can be sufficiently provided.

<Metal Foil Layer>

The metal foil layer 22 serves to secure barrier performance of the armouring material 1, and aluminum foil, stainless foil, and copper foil etc. is used. Aluminum foil is preferably used, in view of the formability and light weight. As a material for the aluminum foil, O-material (soft material) of pure aluminum base or aluminum-iron base alloy is preferably used.

It is necessary that thickness of the metal foil layer 22 ranges from 20 to 80 μm to secure processability and barrier performance preventing oxygen or water from penetrating into the interior of the air secondary battery. If thickness is 20 μm or more, then breaking of the metal foil layer 22 is unlikely to occur when molding the armouring material 1, pinholing is unlikely to occur, thereby penetration of oxygen or water can be prevented. In addition, if thickness is 80 μm or less, then improving effect of breaking or preventing effect of pinholing when molding can be held, and further, total thickness of the armouring material 1 does not excessively increase, increasing of weight can be prevented, thereby improving the volume energy density of the air secondary battery.

In addition, with respect to the metal foil layer 22, undercoating treatment by silane coupling agent or titan coupling agent, or chemical conversion treatment by chromate conversion treatment is preferably performed, in order to improve adhesiveness to the outer layer 21 and the inner layer 23, or corrosion resistance.

<Inner Layer>

Next, the inner layer 23 is constituted from a thermoplastic resin film. As the thermoplastic resin film used in the inner layer 23, preferred are those having heat sealing property, serving to improve chemical resistance against highly corrosive electrolyte for use in an air secondary battery, and being capable of securing insulating properties between the metal foil layer 22 and an air electrode or a negative electrode of an air secondary battery, for example, unstretched polyolefin film such as polypropylene, malleic acid modified polypropylene, and unstretched film such ethylene-acrylate copolymer and ionomer resin is preferably used.

In particular, as the inner layer 23, acid modified polyolefin is preferable, carboxylic acid modified polyolefin film is more preferable, for example, maleic anhydride modified polyethylene or maleic anhydride modified polypropylene etc. is preferable.

Thickness of the inner layer 23 ranges preferably from 0.1 to 200 μm, more preferably from 50 to 100 μm. If thickness is 0.1 μm or more, preferably 50 μm or more, then heat sealing strength becomes sufficient, and corrosion resistance to the electrolyte can be improved, and the insulative property between the metal foil layer 22 and the negative electrode can be improved. In addition, if thickness is 200 μm or less, preferably 100 μm or less, then both the heat sealing property and the chemical resistance are not affected, and further, the volume energy density of the air secondary battery can be improved.

In addition, the thermoplastic resin film constituting the inner layer 23 may be composed of either a single thermoplastic resin layer, or a laminated one consisting of plural thermoplastic resin layers. As a specific example of the inner layer constituted from plural thermoplastic resin layers, for example, a three-layered film composed of an intermediate layer and a pair of covering layers laminated on both sides in the direction of thickness with putting the intermediate layer therebetween can be exemplified.

The melting point of the thermoplastic resin film constituting the inner layer 23 ranges preferably from 130° C. to 170° C., more preferably from 160° C. to 165° C. If the melting point is within the range, then heat-resistance of the inner layer 23 can be improved, the thickness of the inner layer 23 upon heat sealing is not likely to decrease, thereby the heat resistance of the inner layer 23 can be improved.

<Sheet Adhesive Layer>

The sheet adhesive layer 24 for laminating is disposed between the inner layer 23 and the metal foil layer 22 to adhere the inner layer 23 with the metal foil layer 22. In addition, between the outer layer 21 and the metal foil layer 22, an adhesive layer is disposed.

As for the adhesive layer, an adhesive layer for use in a dry laminate is preferable, and for example, it is possible to use at least one selected from the group consisting of urethane type, acid modified polyolefin, styrene elastomer, acrylic type, silicone type, ether type, and ethylene-vinyl acetate type.

Thickness of the sheet adhesive layer ranges preferably from 0.1 to 10 μm, more preferably from 1 to 5 μm. If thickness of the sheet adhesive layer is 0.1 μm or more, then adhesive strength does not decrease, and at the side of the inner layer, insulating property can be improved further. In addition, if thickness of the sheet adhesive layer is 5 μm or less, then deterioration of adhesive strength can be prevented.

In particular, with respect to each of the adhesive layer at the outer layer side and the sheet adhesive layer 24 at the inner layer side, it is preferable to use an adhesive layer made of material being different from respectively.

As a combination of material for the sheet adhesive layer, preferably, urethane type adhesion is used as the adhesive at the outer layer side in the case in which the outer layer 21 is constituted from PET or nylon, whereas in the case in which the inner layer 23 is constituted from polypropylene or an acid modified polypropylene, an acrylic type adhesion or an acid modified type adhesion is preferably used as the adhesive at the inner layer side.

By using adhesion of which material is different from each other, as the adhesive layer of the outer layer side and the sheet adhesive layer 24 of the inner layer side, respectively, it is possible to provide the adhesive strength and the electrolyte-resistance between each of material.

In addition, the inner layer 23 and the metal foil layer 22 may be laminated to each other, similarly to the case of the outer layer 21, with intervening the sheet adhesive layer 24 therebetween, or, may be adhered to each other by heat-laminating by using heat-adhesive resin having excellent heat-resistance and electrolyte-resistance, in this case, it is possible to obtain further improved adhesiveness between the inner layer 23 and the metal foil layer 22. In this case, heat-laminating is performed by extruding the heat-adhesive resin such as maleic anhydride modified polypropylene obtained by modifying maleic anhydride, into the gap between the metal foil layer 22 and the inner layer 23. However, it is more cost-effective to use polyolefin in the same line as the thermoplastic resin film of the inner layer 23, such as a co-extrusion resin of polypropylene and modified polypropylene resin to heat laminate the metal foil layer 22 with modified polypropylene, and the inner layer with polypropylene, respectively, than using modified heat adhesive resin in a single layer.

(Oxygen Permeable Membrane)

The oxygen permeable membrane 3 serves to pass oxygen therethrough between outside air and an air electrode of an air secondary battery, and to prevent leaking out of electrolyte from the inside of a battery and penetration of water or carbon dioxide into the inside of a battery.

The oxygen-permeable membrane 3 in this embodiment is constituted from the porous fluororesin membrane in which particles of fluorine type resin are aggregated, for example, fluororesin (carbon fluoride resin) consisting of only fluorine atoms and carbon atoms such as PTFE (poly-tetra-fluoro-ethylene; TEFLON (registered trademark)), PVDF (polyvinylidene difluoride), and a copolymer of tetrafluoroethylene and hexafluoropropylene (EFP) are exemplary. These materials have characteristics of being chemically stable, and excelling in thermal resistance and chemical resistance. As the oxygen permeable membrane 3 used in this embodiment, it is preferable to use porous fluororesin membrane consisting of PTFE resin, from the view point of excelling in the oxygen-permeability and water repellency. It should be noted that the resin membrane above which constitutes the oxygen-permeable membrane, may be those on which corona treatment, UV treatment, or plasma treatment has been effected, for the purpose of improving adhesiveness.

The oxygen-permeable membrane 3 is, as mentioned above, a porous fluororesin membrane in which particles of fluorine type resin are pushed to be fixed, thereby aggregating porous fluororesin membrane. The porous fluororesin membrane as such has excellent oxygen permeability and a surface having unevenness because of residual particles left on the surface of the membrane, such that the adhesive which constitutes the adhesive layer 5 penetrates into the unevenness to increase adhesive strength, i.e. an anchor effect can be obtained. In addition, since fluororesin excels in water repellency, in the case in which the armouring material 1 is used to constitute an air secondary battery, it is possible to prevent water from invading thereinto efficiently. In the case in which a resin material other than fluorine type resin is used, it may be difficult to secure water repellency.

The thickness of the oxygen permeable membrane 3 ranges preferably from 0.1 to 100 μm, and more preferably from 20 to 70 μm.

As shown in FIG. 4, the primer layer 3c is formed on the joining surface of the outer periphery 3a of the oxygen-permeable membrane 3. The primer layer 3c is a layer which is activated by, for example, a compound material having a molecular constitution containing at least one or more of polar group of hydroxyl group, carbonyl group, amino group, nitro group, cyano group, silanol group, carboxyl group, isocyanate group, amide group, and epoxy group, or a primer consisting of peroxide and silica fine particles. As a result that the primer layer 3c is formed on the oxygen-permeable membrane 3, and that the primer layer 3c comes into contact with the adhesive layer 5 mentioned below, an effect that joining strength can be heightened, even if using the oxygen-permeable membrane 3 made of a hardly-adhesive material such as porous fluororesin membrane, is obtained. In addition, in the case in which cyanoacrylic type resin is used for the adhesive layer 5, the joining strength between the oxygen-permeable membrane 3 and the armouring sheet 1 is further significantly heightened.

As a result of forming the primer layer 3c as above, the joining surface of the oxygen-permeable membrane 3 is activated. As the reason why the joining strength is heightened, it can be thought that by applying thinly the primer layer 3c consisting of a dilute adhesive component, the adhesive component penetrates into the oxygen-permeable membrane 3 as an adherend, thereby increasing the adhesive strength. In addition, it can be thought that as a result of forming a substance having polar groups on the joining surface of the oxygen-permeable membrane 3, the affinity to the adhesive layer 5 is heightened. In addition, in the case in which the joining surface of the oxygen-permeable membrane 3 as an adherend is roughened, an anchor effect is provided.

As the compound material, for activating the oxygen-permeable membrane 3 by primer treatment, those having a molecular constitution containing at least one or more of polar group of hydroxyl group, carbonyl group, amino group, nitro group, cyano group, silanol group, carboxyl group, isocyanate group, amide group, and epoxy group, for example, those disclosed in Japanese Patent Laid-Open No. 2002-201426, Japanese Patent Laid-Open No. 2003-41155, and Japanese Patent Laid-Open No. 2005-171061 can be used, without limitation.

In addition, in the case in which the primer treatment is performed using a mixture material of peroxide and silica fine particles, for example, the mixture material disclosed in Japanese Patent Laid-Open No. 2011-246669 can be used, without limitation.

(Adhesive Layer)

As the adhesive layer 5 for joining the oxygen-permeable membrane 3 with the armouring sheet 2, by adhering, for example, cyanoacrylic type adhesive can be used.

In order to secure sufficient adhesive strength between the oxygen-permeable membrane 3 and the armouring sheet 2, the thickness of the adhering layer ranges preferably from 0.01 to 100 μm, and more preferably from 0.1 to 10 μm.

And further, in the embodiment, in addition to the primer layer 3c formed on the above mentioned oxygen-permeable membrane 3, the primer layer 5a is preferably formed further on the joining surface at a side of the oxygen-permeable membrane 3 of the adhesive layer 5, as shown in FIG. 4. In this way, the primer layer 3c comes into contact with the primer layer 5a, such that an activated region is joined with another activated region, thereby it is possible to join the space between the layers more strongly.

[Production Method of an Armouring Material for Use in an Air Secondary Battery]

Next, it will be explained with respect to the production method of the armouring material 1, below.

The production method of the armouring material 1 which is an embodiment of the present invention is constituted from:
a step of forming the armouring sheet 2 constituted by laminating an outer layer 21 including heat-resistant resin film, a metal foil layer 22, and an inner layer 23 including a thermoplastic resin film, being equipped with an opening part 12 for taking oxygen in, perforating through the outer layer 21, the metal foil layer 22 and the inner layer 23;
a step of conducting a primer treatment on the oxygen-permeable membrane 3 which is constituted from a porous fluororesin in which fluorine type resin particles are aggregated, thereby forming a primer layer 3c on the outer periphery 3a of the oxygen-permeable membrane 3;
a step of applying an adhesive to at least the joining surface in the vicinity of the opening 12a in the surface at the side of inner layer 23 of the armouring sheet 2 to form an adhesive layer 5; and
a step of joining the oxygen-permeable membrane 3 to the circumference of the opening of the armouring sheet 2 by the adhesive layer 5.

As the production method of the oxygen-permeable membrane 3 used in the embodiment, for example, a method of processing particles of fluororesin such as PTFE, PVDF and FEP into a sheet through a sintering method, a dispersion method, a paste extruding method, and a hot pressing to obtain a porous fluororesin film is exemplary. Since, in these methods, fluororesin particles are sintered at a temperature less than the melting point thereof, such that voids remain in between the particles, thereby the oxygen-permeable membrane 3 becomes porous.

In addition, to the resultant porous fluororesin film processed into a sheet, roll-pressing may be effected further, until it becomes a predetermined thickness. In addition, it is also possible to obtain the oxygen-permeable membrane 3 shaped in a sheet, by slicing thinly the fluorine type resin which is subjected to compression molding into a bulk.

And, by performing a primer treatment on the outer periphery 3a of the resultant oxygen-permeable membrane 3 obtained by the method in the above, to activate the oxygen-permeable membrane 3, thereby forming the primer layer 3c.

At this time, by activating the outer periphery 3a of the oxygen permeable membrane 3 using a compound material having a molecular constitution including one or more of hydroxyl group, carbonyl group, amino group, nitro group, cyano group, silanol group, carboxyl group, isocyanate group, amide group, and epoxy group, or a primer consisting of peroxide and silica fine particles, the primer layer 3c can be formed.

In the primer treatment in the above, for example, by dripping a primer in an arbitrary amount to the joining portion between the inner layer 23 and the oxygen-permeable membrane 3, and then removing an excess of the primer with a paper waste, an application operation is conducted. The application amount in this case ranges preferably from 0.01 mg/m² to 10 mg/m², and more preferably from 0.1 mg/m² to 10 mg/m².

In addition, in the embodiment, a hydrophobic property silane treating agent may be applied to the oxygen-permeable membrane 3 before or after conducting the primer treatment in the above, it is more preferable after the primer treatment.

In this embodiment, in the step of forming the adhesive layer 5, it is preferred to use cyano acryl type adhesive as a material.

At this time, on the inner layer 23 of the armouring sheet 2, the adhesive layer 5 is formed at least in the vicinity of the opening 12a, for example, the adhesive layer 5 may be formed on wholly at a side of the inner layer 23 of the armouring sheet 2.

In addition, the adhesive layer 5 is formed by applying cyano acrylic type adhesive to the above mentioned portions in a conventional known well method, and then laminating the oxygen-permeable membrane 3 thereon and drying it.

In this embodiment, using the oxygen-permeable membrane 3 in which the primer layer 3c is formed, the oxygen-permeable membrane 3 is adhered to the armouring sheet 2 by the adhesive layer 5 consisting of cyano acrylic type adhesive, and as a result, the adhesive strength increases to heighten the sealing property, thereby preventing leaking out of electrolyte and invasion of water through the joining portion.

In addition, in this embodiment, it is preferable to include the step of forming the primer layer 5a using the primer material and the method similar to the case of the oxygen-permeable membrane 3, to the joining surface at a side of the oxygen-permeable membrane 3 in the adhesive layer 5. Thus, by forming the primer layer 3c at a side of the oxygen-permeable layer 3 and the primer layer 5a at a side of the adhesive layer 5, and thereafter joining these primer layers with each other, the joining strength increases to make the effect of heightening the sealing property more significant.

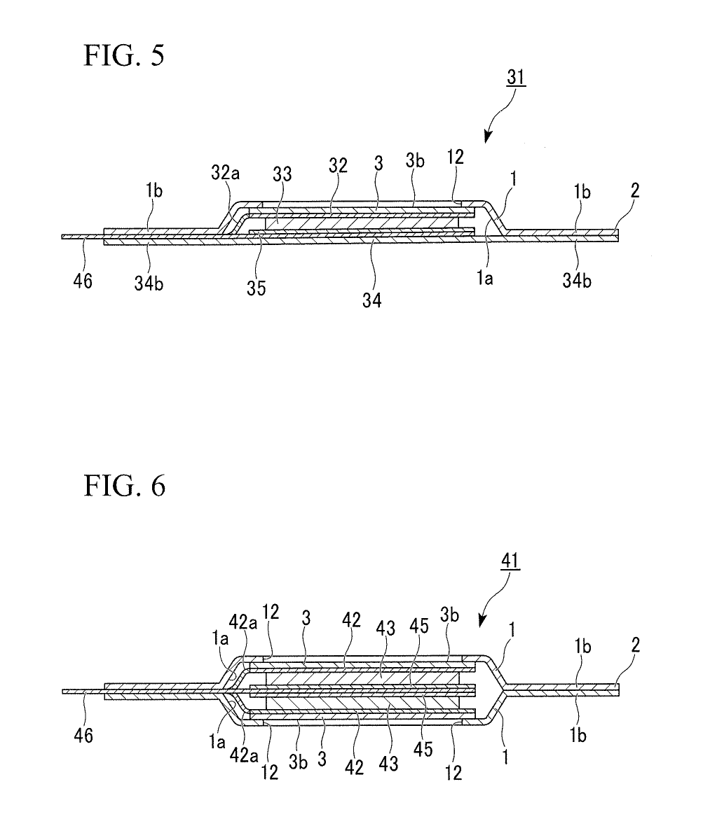

In FIGS. 5 and 6, the air secondary battery using the armouring material 1 in the above is shown. The air secondary battery shown in FIGS. 5 and 6 is a lithium secondary battery using lithium as a negative electrode active material.

It should be noted that, in FIGS. 5 and 6, and the explanations below, indication and explanation of the adhesive layer (see the reference 5 in FIG. 4) joining the armouring sheet 2 and the oxygen-permeable membrane 3, each of the primer layers formed on the armouring sheet 2 and the oxygen-permeable membrane 3 (see the references 5a and 3c) are omitted, corresponding to the necessity of expression.

The lithium air secondary battery 31 shown in FIG. 5 is constituted from at least the air electrode 32, the negative electrode 33, the electrolyte, the air electrode 32, the negative electrode 33 and the armouring materials 1 and 34 wrapping electrolyte. The armouring material 1 is arranged at the air electrode 32 side, and the oxygen permeable membrane 3 connected to the armouring material 1 is piled on the air electrode 32. The air electrode 32 is connected to the air electrode lead 32a. The air electrode lead 32a is projected as a positive terminal to the outside of the armouring materials 1 and 34. In addition, the armouring material 34 is arranged at the negative electrode 33 side. The armouring material 34 is constituted from the same laminate as the armouring sheet 2 constituting the armouring material 1. The outer peripheries 1b and 34b are heat sealed to each other to form approximately a bag. And the air electrode 32, the negative electrode 33 and the electrolyte are inserted into between the armouring materials 1 and 34, and is disposed in the recess 1a of the armouring material 1. In addition, a separator is arranged between the air electrode 32 and the negative electrode 33, if necessary.

The air electrode 32 is constituted by laminating the catalyst layer and the oxygen diffusion layer. The oxygen diffusion layer diffuses the oxygen permeated trough the opening 12 and the oxygen permeable membrane 3 to all over the surface of the catalyst layer. In addition, the catalyst layer captures oxygen to cause the electrode reaction.

The negative electrode 33 is, for example, constituted from metallic lithium foil. The negative electrode 33 is crimped to the collector 35 consisting of metal. The collector 35 is connected to the negative electrode lead 36. The negative electrode lead 36 is projected as a negative terminal to the outside of the armouring materials 1 and 34.

In producing the lithium air secondary battery 31 shown in FIG. 5, the armouring materials 1 and 34 are prepared, and are heat sealed to each other into a bag, the collector 35 and the negative electrode lead 36 are unified with the negative electrode 33, the separator and the air electrode 32 are piled on the negative electrode 33, and these negative electrode 33, the separator, and the air electrode 32 are inserted into the recess 1a of the armouring material 1 through the opening of the bag, and finally, the electrolyte is poured thereinto, and then the opening is heat sealed to obtain the lithium air secondary battery 31.

In addition, the lithium air secondary battery 41 shown in FIG. 6 is constituted from at least the air electrode 42, the negative electrode 43, and the electrolyte, and the armouring materials 1 and 1 wrapping the air electrode 42, the negative electrode 43 and the electrolyte. In the example shown in FIG. 6, each of the collectors 45 and 45, the negative electrodes 43 and 43 consisting of metallic lithium foil, and the air electrodes 42 and 42 is laminated on both surfaces of the negative electrode lead 46, sequentially, and each of the armouring materials 1 and 1 is laminated mutually so as to put the negative electrode 46 and the air electrode lead 42a therebetween, and is heat sealed with each other.

In producing the lithium air secondary battery 41 shown in FIG. 6, the armouring materials 1 and 1 are prepared, and each of them is heat sealed with each other to form a bag, the collector 45 and the negative electrode lead 46 are unified with the negative electrode 43, a separator and the air electrode 42 are laminated on the resultant negative electrode 43, these negative electrode 43, the separator and the air electrode 42 are inserted into the recesses 1a and 1a of the armouring material 1, through the opening of the bag, finally the electrolyte is poured thereinto, then the opening is heat sealed to obtain the lithium air secondary battery. 41

It should be noted that in the example shown in FIGS. 5 and 6, it is explained referring to a lithium air secondary battery, however, the present invention is not limited thereto, for example, the present invention may be applied to an aluminum air secondary battery using aluminum as the negative active material.

As explained above, according to the armouring material 1 as an embodiment of the present invention, it is constituted such that the porous fluororesin membrane is used as the oxygen-permeable membrane 3, the primer layer 3c is formed on the joining surface of the outer periphery 3a of the oxygen-permeable membrane 3 with respect to joining the inner layer 23 of the armouring sheet 2 containing the thermoplastic resin film with the oxygen-permeable membrane 3, and that by providing the adhesive layer 5 between the primer layer 3a and the inner layer 23 of the armouring sheet 2, the oxygen-permeable membrane 3 is adhered to the armouring sheet 2. Thereby, it is possible to obtain excellent oxygen permeability, barrier property of water, and the joining strength between the armouring sheet and oxygen permeable membrane increases to heighten the sealing property, thereby preventing leaking out of the electrolyte and invasion of water through the joining portion. In addition, in the adhesive layer 5, the primer layer 5, the primer layer 5a is provided to the portion corresponding to the outer periphery 3a of the oxygen-permeable membrane 3, and as a result, the joining strength between the oxygen-permeable membrane 3 and the armouring sheet 2 further increases to heighten the sealing property further, thereby the effect of preventing leaking out of electrolyte and invasion of water becomes more significant.

In addition, according to the air secondary battery as an embodiment of the present invention, it has the armouring material 1 having excellent oxygen permeability, and heightened joining strength between the inner layer 23 and the oxygen-permeable membrane 3, and hence battery property is improved, leaking out of electrolyte and invasion of carbon dioxide from the outside, thereby preventing life time of the air secondary battery from decreasing.

Moreover, according to the production method of the armouring material for use in an air secondary battery as an embodiment of the present invention, which adopts the process including, upon joining the armouring sheet 2 inner layer 23 including thermoplastic resin film with oxygen-permeable membrane 3 made of porous fluororesin, a step of forming a primer layer 3c on the outer periphery 3a of the oxygen-permeable membrane 3, and a step of forming an adhesive layer 5 by applying an adhesive to at least the joining surface in the vicinity 12a of the opening in the surface at the side of inner layer 23 of the armouring sheet 2. Thereby, oxygen-permeablity and barrier performance against water can be improved, the joining strength between the inner layer 23 of the armouring sheet 2 and the oxygen-permeable membrane 3 can be improved to heighten the sealing property therebetween, and as a result, the armouring material for use in an air secondary battery being capable of preventing leaking out of electrolyte and invading of water can be obtained.

### EXAMPLE

### Example 1

At first, a commercially available Teflon film (porous Teflon sheet (registered trademark), produced by NIHON BARUCAR Co., Ltd, size: 5 cm×3 cm×0.1 mm) was prepared.

In addition, as an armouring sheet, commercially available aluminum laminate film “ALLAMINATE” C8-480 (registered trademark): produced by Showa Denko Co., Ltd. was prepared.

Next, primer treatment was performed on this oxygen-permeable membrane. At this time, the primer layer was formed by applying a primer to the outer periphery of the oxygen-permeable membrane, using a primer containing heptane. As the primer containing heptane “F primer” (registered trademark): produced by FOUR FRONT Co., Ltd.” was used. And after this solution was applied to the outer periphery of the oxygen-permeable membrane using a brush, it was dried at a room temperature to remove the solvent used for distillation. The application amount was 1 mg/m².

Subsequently, the adhesive layer was formed on the armouring sheet consisting of aluminum laminate sheet as shown in FIG. 1, on which an opening was formed and a recess was formed previously. At this time, as an adhesive material, cyano acrylic type adhesive (product name: Aron Alpha (trade mark) produced by TOA GOSEI Co., Ltd.) which contains a 2-cyano ethyl acrylate as a main component and hydrochinone as an additive was used, and this adhesive was applied to the front surface of the inner layer side of the armouring sheet, using a brush. After the adhesive was applied (after formation of the adhesive layer), immediately, the outer periphery of the oxygen-permeable membrane and the peripheral part of the opening of the armouring sheet was adhered to each other. By the procedure above, the armouring material was produced.

### Example 2

The armouring material was produced by the same way as Example 1, with the exception that a primer which contains acetone, isopropyl alcohol and methylcyclohexane was used as the primer for forming the primer layer on the outer periphery of the oxygen-permeable membrane, and a cyanoacrylic type adhesive “FRONT#105G (Trademark), produced by FOUR FRONT Co., Ltd.” which contains ethyl-2-cyanoacrylate as the main component and polymethylmethacrylate as an additive was used as the adhesive used in the adhesive layer.

### Comparative Example 1

An armouring material was produced under the same condition as Example 1 with the exception that adhering the oxygen permeable membrane and an armouring sheet was tried without performing primer treatment on the oxygen-permeable membrane.

### Comparative Example 2

An armouring material was produced under the same condition as Example 2 with the exception that adhering the oxygen permeable membrane and an armouring sheet was tried without performing primer treatment on the oxygen-permeable membrane.

### Comparative Example 3

An armouring material was produced under the same condition as Example 1 with the exception that adhering the oxygen permeable membrane and an armouring sheet by welding through heat-sealing was tried without performing primer treatment on the oxygen-permeable membrane and without using adhesive.

With respect to obtained armouring material, the adhesiveness was evaluated by measuring the peel strength between the oxygen-permeable membrane and the armouring sheet.

As a condition of this evaluation, in addition to the condition of stress addition free, the peel strength was evaluated with respect to each of after immersing the armouring material in a water for 24 hours and after immersing the armouring material in an electrolyte for 24 hours. In addition, the peel strength was measured according to its K 6854-2, under a condition that the oxygen-permeable membrane was fixed. In other words, cutting the armouring sheet to which a ceramic layer was adhered into 15 mm width, and the peeling test between the ceramic layer and the armouring sheet was performed thereon and evaluated.

It should be noted that in the immersion in water, ion exchanged water was used, in the immersion in an electrolyte, LiTFSA (electrolyte)-PP13TFSA (electrolytic solution) was used as a non-aqueous electrolyte, and aqueous LiOH was used as an aqueous electrolyte. Result of each of evaluation is shown in Table 1 below.

As shown in Table 1 below, in Examples 1 and 2 in which the primer layer was formed on the oxygen-permeable membrane, and the oxygen-permeable membrane and the armouring sheet was adhered to each other, excellent sealing property (adhesiveness) was obtained. On the other hand, in Comparative Examples 1 and 2, in which adhering the oxygen-permeable membrane with the armouring sheet was tried without forming the primer layer on the oxygen-permeable membrane, it could not joined. In addition, in Comparative Example 3, in which joining the oxygen-permeable membrane with the armouring sheet by welding through heat-sealing, it could not joined.

TABLE 1

| | Primer | | Adhesiveness |
|---|---|---|---|
| | treatment | Joining method | (seal efficiency) |
| Example 1 | Exist | Adhesive | ◯ (Good) |
| | (F primer) | (Aron Alpha) | |
| Example 2 | Exist | Adhesive | ◯ (Good) |
| | (F primer) | (FRONT #105G) | |
| Comparative | None | Adhesive | X (It cannot be sealed) |
| Example 1 | | (Aron Alpha) | |
| Comparative | None | Adhesive | X (It cannot be sealed) |
| Example 2 | | (FRONT #105G) | |
| Comparative | None | Heat seal | X (It cannot be sealed) |
| Example 3 | | | |

In addition, as shown in FIG. 5, the armouring material 1 and the armouring material 34 were mutually heat sealed to form a bag, the resultant bag is filled with a non-aqueous electrolytic solution in which stain solution was added, and then the bag was sealed to obtain test sample, thereafter, with respect to the resultant test sample, it was evaluated on whether leaking was occurred or not. For dyeing the electrolytic solution, 1 wt. % of rhodamine B ethanol solution in an amount of 1 vol. % was added to the electrolytic solution. As the electrolytic solution, an electrolytic solution obtained by dissolving 1 mol/L of LiPF₆ into a mixed solvent consisting of ethylenecarbonate and diethylcarbonate contained at the ratio of ethylenecarbonate:diethylcarbonate=1:1 (volume ratio) was used.

The result regarding whether leaking is present or absent is shown in Table 2, below. In Examples 1 and 2, in which the primer layer was formed on the oxygen-permeable membrane, and the oxygen-permeable membrane was adhered to the armouring sheet, no leaking of the electrolyte was observed even after 30 days. Whereas, in Comparative Examples 1 and 2 in which no primer layer was formed on the oxygen-permeable membrane, and in Comparative Example 3 in which it was tried to join the oxygen-permeable membrane to the armouring sheet by welding, the oxygen-permeable membrane could not be joined to the armoring sheet.

TABLE 2

| | Primer | | |
|---|---|---|---|
| | treatment | Joining method | Leaking resistance |
| Example 1 | Exist | Adhesive | ◯ (None) |
| | (F primer) | (Aron Alpha) | |
| Example 2 | Exist | Adhesive | ◯ (None) |
| | (F primer) | (FRONT #105G) | |
| Comparative | None | Adhesive | X (It cannot be sealed) |
| Example 1 | | (Aron Alpha) | |
| Comparative | None | Adhesive | X (It cannot be sealed) |
| Example 2 | | (FRONT #105G) | |
| Comparative | None | Heat seal | X (It cannot be sealed) |
| Example 3 | | | |

In addition, with respect to the resultant armouring material, the gas permeability test specified in JIS K 7126-1 was conducted to evaluate the oxygen permeating amount. As the gas used in this test, oxygen gas (99.99%) was used. In addition, the temperature in the test was a room temperature, and the differential pressure was 100 kPa (Supply side: 100 kPa, Permeation side: 0 kPa). In addition, as the sample in this test, those obtained by cutting the air electrode side of the sample used in the aforementioned electrolytic solution leaking test were used, and the gas permeation test was conducted on the sample which was inserted into the test cell. The result of the gas permeation test is shown in Table 3, below:

TABLE 3

| | Primer | | Oxygen permeating |
|---|---|---|---|
| | treatment | Joining method | amount |
| Example 1 | Exist | Adhesive | 4420 cc/m² (24 h/atm) |
| | (F primer) | (Aron Alpha) | |
| Example 2 | Exist | Adhesive | 4400 cc/m² (24 h/atm) |
| | (F primer) | (FRONT #105G) | |
| Comparative | None | Adhesive | It cannot be sealed, |
| Example 1 | | (Aron Alpha) | unmeasurable. |
| Comparative | None | Adhesive | It cannot be sealed, |
| Example 2 | | (FRONT #105G) | unmeasurable. |
| Comparative | None | Heat seal | It cannot be sealed, |
| Example 3 | | | unmeasurable. |

As shown in Table 3, in Examples 1 and 2, in which the primer layer was formed on the oxygen-permeable membrane, and the oxygen-permeable membrane was adhered to the armouring sheet, it was confirmed that the oxygen permeating amount is sufficient. Whereas, in Comparative Examples 1 and 2 in which the primer layer was not formed on the oxygen-permeable membrane, in Comparative Example 3 in which joining by welding between the oxygen-permeable membrane and the armouring sheet was tried, the oxygen-permeable membrane and the armouring sheet could not be joined to each other, and hence it could not be measured precisely the oxygen permeating amount.

### DENOTATION OF REFERENCE NUMERALS

1 . . . the armouring material for use in an air secondary battery, 2 . . . the armouring sheet, 3 . . . the oxygen permeable membrane, 3a . . . the outer periphery of the oxygen permeable membrane, 3c . . . the primer layer, 5 . . . adhesive layer, 5a . . . the primer layer, 12 . . . the opening, 12a . . . peripheral part of the opening, 21 . . . the outer layer, 22 . . . the metallic foil layer, 23 . . . the inner layer, 31, 41 . . . the air secondary battery.

1. An armouring material for use in an air secondary battery, comprising an armouring sheet constituted by laminating an outer layer including heat-resistant resin film, a metal foil layer, and an inner layer including a thermoplastic resin film, being equipped with an opening part for taking oxygen in, perforating through the outer layer, the metal foil layer and the inner layer, and
an oxygen-permeable membrane being joined to the inner layer side in the opening part periphery so as to cover the opening part,
wherein the oxygen-permeable membrane is constituted from a porous fluororesin in which fluorine type resin particles are aggregated, the joining surface of outer periphery of the oxygen-permeable membrane is equipped with a primer layer, and an adhesive layer is provided at least in the space between the primer layer and the inner layer of the armouring sheet, thereby adhering the oxygen-permeable membrane to the armouring sheet.

2. The armouring material for use in an air secondary battery as set forth in claim 1, further comprising a primer layer on the joining surface at the side of the oxygen-permeable membrane of the adhesive layer, and the space between the primer layer formed on the side of oxygen-permeable membrane and the primer layer formed at the side of the armouring sheet is joined.

3. The armouring material for use in an air secondary battery as set forth in claim 1, wherein the fluorine type resin is polytetrafluoroethylene resin, poly(vinylidene fluoride) resin, or copolymer of tetrafluoroethylene and propylene hexafluoride (EFP).

4. The armouring material for use in an air secondary battery as set forth in claim 1, wherein the primer layer is a layer which is activated by a compound material having a molecular constitution containing at least one or more of hydroxyl group, carbonyl group, amino group, nitro group, cyano group, silanol group, carboxyl group, isocyanate group, amide group, and epoxy group; or a primer consisting of a mixed material of peroxide and silica fine particles.

5. The armouring material for use in an air secondary battery as set forth in claim 1, wherein the adhesive layer is composed of cyanoacrylic type adhesive.

6. The armouring material for use in an air secondary battery as set forth in claim 1, wherein the inner layer is composed of an acid denaturated polyolefin resin film.

7. The armouring material for use in an air secondary battery as set forth in claim 1, wherein the armouring material is composed of polyamide resin film, or polyester resin film.

8. An air secondary battery comprising the armouring material for use in an air secondary battery as set forth in claim 1.

9. A process for producing the armouring material for use in an air secondary battery as set forth in claim 1, comprising:
a step of forming the armouring sheet constituted by laminating an outer layer including heat-resistant resin film, a metal foil layer, and an inner layer including a thermoplastic resin film, being equipped with an opening part for taking oxygen in, perforating through the outer layer, the metal foil layer and the inner layer;
a step of conducting a primer treatment on the oxygen-permeable membrane which is constituted from a porous fluororesin in which fluorine type resin particles are aggregated, thereby forming a primer layer on the outer periphery of the oxygen-permeable membrane;
a step of applying an adhesive to at least the joining surface in the vicinity of the opening in the surface at the side of inner surface of the armouring sheet to form an adhesive layer; and
a step of joining the oxygen-permeable membrane to the circumference of the opening of the armouring sheet by the adhesive layer.

10. The process for producing the armouring material for use in an air secondary battery as set forth in claim 9, further comprising:
a step of forming a primer layer on the joining surface at the side of the oxygen-permeable membrane of the adhesive layer, and joining the primer layer formed at the side of the oxygen-permeable membrane with the primer layer formed at the side of the adhesive layer.

11. The process for producing the armouring material for use in an air secondary battery as set forth in claim 9, wherein the primer layer is formed by activation using a primer consisting of a compound material having a molecular constitution containing at least one or more of hydroxyl group, carbonyl group, amino group, nitro group, cyano group, silanol group, carboxyl group, isocyanate group, amide group, and epoxy group; or a primer consisting of a mixed material of peroxide and silica fine particles.

12. The process for producing the armouring material for use in an air secondary battery as set forth in claim 9, wherein the adhesive layer is formed from cyanoacrylic type adhesive.
